(19) United States
(12) Patent Application Publication
(10) Pub. No.: US 2019/0061315 A1
(43) Pub. Date: Feb. 28, 2019

(54) MOVABLE AQUATIC TILE MOSAIC SYSTEMS AND METHODS

(71) Applicants: Christian D. Trinidade, Chelmsford, MA (US); Katharine E. Slowe, Chelmsford, MA (US)

(72) Inventors: Christian D. Trinidade, Chelmsford, MA (US); Katharine E. Slowe, Chelmsford, MA (US)

(21) Appl. No.: 15/904,900

(22) Filed: Feb. 26, 2018

Related U.S. Application Data
(63) Continuation-in-part of application No. 15/479,254, filed on Apr. 4, 2017, now abandoned.
Application No. 15/479,254 is a substitute for application No. 62/317,843, filed on Apr. 4, 2016.

(51) Int. Cl. B32B 7/12; E04H 4/14; B32B 3/14; B32B 9/00; B32B 25/04; B32B 37/12

(52) U.S. Cl. CPC B32B 7/12; E04H 4/14; B32B 3/14; B32B 2419/04; B32B 25/04; B32B 37/12; B32B 9/005

(57) ABSTRACT

A movable aquatic tile mosaic system comprising a water-filled enclosure and a mosaic tile composite that adheres to surfaces of both soft and hard-shell pools, without tools and without use of cementitious or epoxy/glue adhesives. The mosaic tile composite comprises tile, mesh, and a flexible adhesive compound used to provide structural integrity and adhesion. The mosaic tile composite relies on the weight of the water at the pool bottom or side surface to flex and conform to convex, concave, sloped, or otherwise uneven pool bottom surfaces, and to cause a traction and/or vacuum/suction interface between the mosaic tile composite and pool surface.

### RELATED APPLICATIONS

This application is a continuation-in-part of U.S. application Ser. No. 15/479,254, filed Apr. 4, 2017, which claims priority to U.S. Provisional Application No. 62/317,843, filed on Apr. 4, 2016. The entire teachings of the above applications are incorporated herein by reference.

### BACKGROUND OF THE INVENTION

Currently there are decorative ceramic tile mosaics mounted on some sort of mesh or delivered in individual pieces that are designed to be adhered to the surface of empty dry swimming pools, typically via a curing cementitious paste formula in a concrete based pool or by a curing epoxy/glue material in non-concrete based pools. Unfortunately, this usually limits the installation window to time of original construction or time of a rebuild or resurface that requires the pool to be drained. Installation of these traditionally mounted mosaics is possible without draining the pool but finding a proper bonding material and grout for underwater installation is not trivial and the labor under water is not ideal. Few tile installers are interested in such a challenge. Regardless, the typical tile mosaics on mesh are designed to be adhered to the bottom of a pool via an introduced cementitious or epoxy/glue bonding agent so the mosaic will not move around from the originally installed location or fold over on itself due to water movement.

The adhesive media between a traditionally installed ceramic tile mosaic and the pool shell that prevents the mosaics from moving or folding over or otherwise distorting also prevents the pool owner from relocating or removing the ceramic mosaic. Removal of a traditionally installed mosaic requires the compromise of the adhesive interface between the mosaic tile bottom and the pool mounting surface. Removal likely also involves damaging the aesthetics of the pool surface at the mosaic location. Preferably, removal would take place in a drained pool. Removing a traditionally installed mosaic would likely damage the ceramic mosaic to a point where relocation in another part of the pool or into another pool would not be desirable.

A need therefore exists for a ceramic tile mosaic composite that can conform and adhere to a pool bottom and/or side, and that would allow for removal or relocation without the need of tools or risk to the pool shell surface.

### SUMMARY OF THE INVENTION

The current invention comprises a tile mosaic composite that contact adheres to the pool bottom, does not need the pool to be drained, and does not necessitate the use of a cementitious or epoxy/glue like adhesive to stay where intended due to water movement. It allows a pool owner to simply insert fingers underneath one edge of the mosaic and lift. This action creates a degree of buoyancy that will allow for damage free transport to another part of the pool or out of the pool for relocation or storage.

This invention allows for tile mosaics to be installed by a pool owner in any water-filled enclosure such as a swimming pool. This invention employs a silicone substance between each tile segment through to the silicone and mesh base. The weight of the mosaic composite gets enhanced by the weight of the water, forcing the silicone substance between the tile segments to expand from the glazed tile segments on top of the composite to the direction of the silicone/mesh base. This allows the mosaic composite to conform to the bottom of the pool, allowing the complete surface area of the silicone rubber/mesh base to interface with the pool bottom. The silicone rubber substance between the tile segments of the mosaic and the silicone rubber/mesh compound enables it to keep the form intended by the artist and mosaic manufacturer regardless of water movement. The traction and in many cases suction provided by the silicone rubber/mesh base of the mosaic composite maintains the desired installation location. These are significant improvements to the existing system in that no draining of the pool is required, no adhesive is needed to maintain the intended form or placement, and soft shell (i.e. vinyl liner) pools are not excluded.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1: Cutaway view of the movable aquatic tile mosaic system.

FIG. 2: Cross section of mosaic tile composite showing three layers. A top layer consisting of a tile mosaic laid flat with a flexible adhesive compound attaching each tile within the mosaic edge to edge and reaching though to layer two. A second layer of mesh permeated by the same flexible adhesive compound used in layer one. Then a third layer consisting of just the flexible adhesive compound.

FIG. 3: Top view of the composite showing the tile mosaic with the flexible adhesive compound between the tile segments.

### DETAILED DESCRIPTION OF THE INVENTION

For the purposes of this invention:
1. the term “water-filled enclosure” refers but is not limited to: swimming and decorative pools, fountains, and artificial lakes and ponds;
2. the term “tile” refers but is not limited to, tiles comprising one or more of: glazed or unglazed ceramic, porcelain, glass, synthetic polymers, and artificial and natural stone.

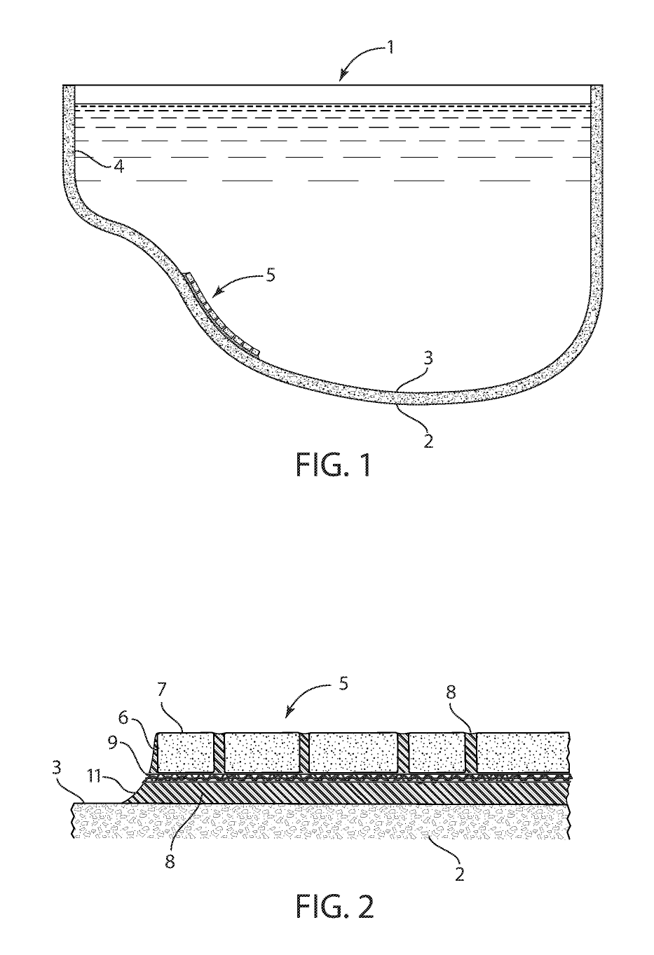

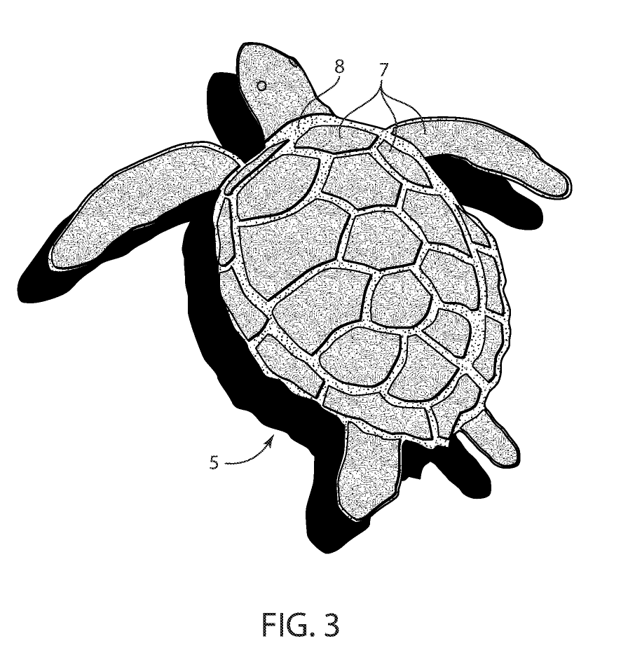

The contemplated invention is a movable aquatic tile mosaic system 1 comprising a water-filled enclosure 2 and a mosaic tile composite 5. In a preferred embodiment, as shown in FIG. 1, the water-filled enclosure 2 comprises a bottom surface 3 and at least one side surface 4. The bottom surface 3 and at least one side surface 4 are contiguous. As shown in FIG. 2, the mosaic tile composite 5 comprises: a first layer 6 consisting of at least two tile segments 7 and a flexible adhesive compound 8 mechanically bonding adjoining edges of the at least two tile segments 7; a second layer 9 consisting of a mesh 10 permeated with a flexible adhesive compound 8, the flexible adhesive compound in mechanical bond with the flexible adhesive compound 8 of the first layer; and a third layer 11 comprising a flexible adhesive compound 8 wherein the flexible adhesive compound 8 is in mechanical bond with the flexible adhesive compound 8 of the first layer 6 and the flexible adhesive compound 8 of the second layer 9. The mosaic tile composite 5 is disposed within the water-filled enclosure 2, and the weight of the water in the water-filled enclosure 2 serves to flex and conform the mosaic tile composite 5 to convex, concave, sloped, or otherwise uneven bottom surface 3 and/or at least one side surfaces 4 of the water-filled enclosure 2. The weight of the water also serves to cause a traction and/or vacuum/suction interface between the flexible adhesive compound 8 of the third layer 11 and the bottom and/or at least one side surfaces 3,4 of the water-filled enclosure 2.

In another preferred embodiment, the at least two tile segments 7 in the first layer 6 of the mosaic tile composite 5 comprise glazed ceramic. Glazed ceramic tile is widely available and well known for its durability in aquatic environments. It is also a dense and heavy material and combined with the weight of the water column in the water-filled enclosure 2, these qualities assist in allowing the mosaic tile composite 5 to flex and conform to the contours of the bottom surface 3 and or at least one side surfaces 4 of the water-filled enclosure 2.

In yet another embodiment, the respective flexible adhesive compounds 8 of the first layer 6, second layer 9 and third layer 11 of the mosaic tile composite 5 comprise silicon and rubber. Notably, the flexible adhesive compound 8 of the first layer of the mosaic tile composite 5 serves to maintain the spacing and relative placement of the at least two tile segments 7.

In another embodiment, a method for making a movable aquatic tile mosaic comprises:
a. providing at least two tile segments;
b. bonding adjoining edges of the at least two tile segments with a flexible adhesive compound;
c. permeating a mesh with a flexible adhesive compound;
d. applying the mesh to the bottom surface of the at least two tile segments such that the flexible adhesive compounds of steps b and c form a mechanical bond;
e. applying a layer of flexible adhesive compound to the mesh of step d causing formation of a monolithic mechanical bond between all flexible adhesive compounds used in steps b-e.

### DISCUSSION AND EXAMPLE

A composite was formed using a flat top layer of glazed ceramic tile segments adhered to mesh. A silicone-based substance was then applied between the interior tile segments, down through to the bottom of the mesh. The same silicone rubber-based material was then applied to the non-glazed tile/mesh base, thereby completing the composite. The silicone-based rubber material between the tile segments of this invention keep the mosaic arrangement as intended by maintaining adherence between the tile pieces upon movement, expansion, or contraction. Currently available mosaics have tile segments which dislodge, fold over the mosaic or misalign on their mesh upon the same movements. The silicone-based rubber material of the mosaic composite provided a tractive and sometimes vacuumed interface that allowed for maintaining desired placement when disposed within a water-filled enclosure even when exposed to pool vacuums and turbulent water.

This was accomplished without the use of a cementitious or epoxy glue adhesive that a traditionally installed mosaic would need to prevent unintended relocation or positioning. Because the mosaic composite described is preformed, self-contained and does not require any adhesive, it is easily installed, relocated and removed without draining the pool and without the use of tools.

While there has been illustrated and described what is at present considered to be the preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed, but that the invention will include all embodiments falling within the scope of the appended claims.

What is claimed is:

1. A movable aquatic tile mosaic system comprising:
a. a water-filled enclosure comprising a bottom surface and at least one side surface and wherein the bottom surface and at least one side surface are contiguous;
b. a mosaic tile composite comprising:
i. a first layer consisting of at least two tile segments and a flexible adhesive compound mechanically bonding adjoining edges of the at least two tile segments;
ii. a second layer consisting of a mesh permeated with a flexible adhesive compound, the flexible adhesive compound in mechanical bond with the flexible adhesive compound of the first layer;
iii. a third layer of a flexible adhesive compound wherein the flexible adhesive compound is in mechanical bond with the flexible adhesive compound of the first layer and the flexible adhesive compound of the second layer; and
wherein the mosaic tile composite of step b is disposed within the water-filled enclosure, and the weight of the water in the water-filled enclosure serves: to flex and conform the mosaic tile composite to convex, concave, sloped, or otherwise uneven bottom and/or side surfaces of the water-filled enclosure; and to cause a traction and/or vacuum/suction interface between the flexible adhesive compound of the third layer and the bottom and or at least one side surfaces of the water-filled enclosure.

2. The movable aquatic tile mosaic system of claim 1, wherein the at least two tile segments of step b comprise ceramic.

3. The movable aquatic tile mosaic system of claim 1, wherein the respective flexible adhesive compounds of the first, second and third layers comprise silicon and rubber.

4. The movable aquatic tile mosaic system of claim 1, wherein the flexible adhesive compound of the first layer serves to maintain the spacing and relative placement of the at least two tile segments.

5. A method for making a movable aquatic tile mosaic comprising:
a. providing at least two tile segments;
b. bonding adjoining edges of the at least two tile segments with a flexible adhesive compound;
c. permeating a mesh with a flexible adhesive compound;
d. applying the mesh to the bottom surface of the at least two tile segments such that the flexible adhesive compounds of steps b and c form a mechanical bond;
e. applying a layer of flexible adhesive compound to the mesh of step d causing formation of a monolithic mechanical bond between all flexible adhesive compounds used in steps b-e.
